(19) United States
(12) Patent Application Publication
(10) Pub. No.: US 2026/0352712 A1
(43) Pub. Date: Nov. 5, 2026

(54) INTENT-BASED MANAGEMENT METHOD AND APPARATUS FOR IN-NETWORK COMPUTING FUNCTIONS

(71) Applicant: Research & Business Foundation Sungkyunkwan University, Suwon-si (KR)

(72) Inventors: Jaehoon JEONG, Busan (KR); Yiwen SHEN, Suwon-si (KR); Yoseop AHN, Suwon-si (KR)

(73) Assignee: Research & Business Foundation Sungkyunkwan University, Suwon-si (KR)

(21) Appl. No.: 19/277,799

(22) Filed: Jul. 23, 2025

(30) Foreign Application Priority Data
Jul. 23, 2024 (KR) 10-2024-0096805
Oct. 21, 2024 (KR) 10-2024-0143534
Jul. 16, 2025 (KR) 10-2025-0095826

(51) Int. Cl. H04L 9/40

(52) U.S. Cl. CPC H04L 63/20

(57) ABSTRACT

According to one embodiment of the present disclosure, there is provided a method performed by a first device within an intent-based network (IBN) framework, including translating an intent received from a user into a high-level policy, transmitting the high-level policy to a second device, receiving a result of monitoring an operation and/or performance of a service function (SF) from the second device, and analyzing the operation and/or performance of the SF based on the monitoring result. The high-level policy is i) a network policy (NP) or ii) an application policy (AP), and the SF is performed by the second device based on the high-level policy.

### CROSS REFERENCE TO RELATED APPLICATION

This application claims the benefit of and priority to Korean Patent Application No. 10-2024-0096805, filed on Jul. 23, 2024, No. 10-2024-0143534, filed on Oct. 21, 2024, and No. 10-2025-0095826 filed on Jul. 16, 2025, the entire disclosure(s) of which is hereby incorporated herein by reference in its entirety.

### TECHNICAL FIELD

The present disclosure relates to an intent-based system (IBS), and more particularly, to an IBS method and apparatus for in-network computing functions (ICFs) of moving objects (MOs) such as a robot, a software-defined vehicle (SDV), and a drone.

### BACKGROUND ART

With the rapid advancement of an artificial intelligence (AI) technology, digital infrastructure is evolving into increasingly large-scale and flexible forms, and in particular, the application of AI-based services and automation in a cloud-based environment is accelerating. Due to these advancements and the increasing complexity of digital systems, the demand for more intelligent and autonomous system operations is increasing. Modern systems are transitioning to more abstract, scalable, and dynamic approaches by adopting programmable control planes, intent-based composition models, and automated orchestration frameworks. For example, infrastructure-as-code (IaC) tools such as Ansible and Terraform support consistent version control, and the Kubernetes platform provides a basic mechanism for autoscaling, self-healing, and policy enforcement based on the observed state of the system.

An intent-based system (IBS) is actively discussed as a solution for managing the increasing complexity and dynamism of modern infrastructure. The IBS can allow users or administrators to specify high-level intents corresponding to “what” they want without specifically defining “how” the desired deliverables should be achieved, and the IBS can apply the user's (or administrator's) intent to a target system (e.g., a software-defined vehicle (SDV)). In this case, the term “intent” mean a declarative definition of a set of operational goals that a network should fulfill and deliverables that the network should provide without specifying the method of achieving or implementing the operational goals and the deliverables. The intent can be represented in natural language, such as text or voice input, and translated into policies (e.g., network policies and application policies) using a natural language processing (NLP) technology.

The IBS is a technology that aims to automate network configuration and management by allowing an administrator to specify high-level intents instead of low-level device-specific commands in a network environment, and enables dynamic provisioning, fault tolerance, and automated quality of service (QoS) control by translating user intent expressions into specific network configurations and policies, facilitates autonomous orchestration of distributed resources in a cloud environment to enable service scaling, recovery, and optimization according to user-defined goals, uses AI and machine learning (ML) technologies to enhance decision-making processes, and enables more efficient infrastructure management.

The IBS can be built on the principles of the interface to network security function (I2NSF) architecture, which is a standardized interface that enables policy-based management of various network security functions, such as firewalls, intrusion detection systems, traffic filters, etc. The I2NSF serves as a translation layer that systematically translates user-defined high-level intents into executable low-level policies that comply with the I2NSF data model and interface specifications. Conventionally, most security policies have been established using tools and interfaces produced by each vendor, making collaboration between systems, process automation, and policy changes in heterogeneous network environments difficult. In addition, the emergence of network functions virtualization (NFV) and software-defined networking SDN has further emphasized the need for centralized and automated control of security infrastructure. To address this challenge, the I2NSF framework introduces a standardized mechanism to support the specification, translation, and enforcement of security policies.

In a broader context, the interface to in-network computing functions (I2ICF) framework is an interface for user services in both networks and applications and includes in-network computing functions (ICF) including both the network functions (NF) of NFV and SDN and the application functions (AF) of Internet of Things (IoT) devices, software-defined vehicles, and unmanned aerial vehicles (UAVs). The ICF is used to configure and monitor various services in both network infrastructure and moving objects (MOS). The MOs are self-propelled with wireless communication capabilities such as 5G vehicle-to-everything (V2X) and can be IoT devices, SDVs, and UAVs.

### DOCUMENTS OF RELATED ART

### Non-Patent Documents

A. Leivadeas and M. Falkner, “A survey on intent-based networking,” IEEE Communications Surveys Tutorials, vol. 25, no. 1, pp. 625-655, 2023.2.
P. Lingga, J. Jeong, J. Yang, and J. Kim, “SPT: Security Policy Translator for Network Security Functions in Cloud-Based Security Services,” IEEE Transactions on Dependable and Secure Computing, pp. 1-14, 2024.

### DISCLOSURE

### Technical Problem

With the rapid advancement of an artificial intelligence (AI) technology, it is difficult for the conventional technologies to effectively manage complex and dynamically evolving digital infrastructures, and in particular, even when users or administrators specify high-level intents (“what”), there is a limitation that they need to manually define a specific low-level method (“how”) for implementing the high-level intents in actual systems. The present disclosure is directed to proposing a method of providing a robust framework that enables users or administrators to safely and accurately translate high-level intents into executable low-level configurations in actual systems even when they specify only the high-level intents.

In addition, in the conventional technologies, in heterogeneous network environments, since most security policies are set through vendor-specific tools and interfaces, there are difficulties with interoperability between systems, process automation, and policy changes. The present disclosure is also directed to proposing a standardized method of solving the conventional problems of vendor-dependent security policy settings and enhancing interoperability between heterogeneous network systems, process automation, and ease of policy changes.

In particular, the conventional technologies lack a standardized data model and interface for describing the capabilities of in-network computing functions including in-network network functions and in-network application functions, registering the in-network computing functions with a controller, and configuring and monitoring the in-network computing functions based on user intent. The present disclosure is also directed to proposing a method of defining in-network computing functions required for user services, registering the in-network computing functions with a controller, and providing a standardized data model and an interface for configuring and monitoring the in-network computing functions based on user intent.

In addition, it is difficult for the conventional technologies to efficiently collect and analyze data generated from various intelligent moving objects (IMOs), such as robots, software-defined vehicles, and drones, in applications such as autonomous driving and collaborative sensing, and there is a problem that the system lacks the capability to detect and resolve potential intent conflicts that can arise when multiple users or administrators simultaneously submit intents to an intent-based system (IBS). In addition, there is a limitation that the conventional technologies lack a natural language processing (NLP) engine having domain knowledge of device configuration and operational context to appropriately translate and transmit user intent to various types of IMOs (e. g., robots, SDVs, drones). The present disclosure is also directed to proposing a method of resolving the difficulties of collecting and analyzing data from various IMOs, detecting and resolving conflicts between multiple user intents, and providing a domain knowledge-based NLP engine for intent translation based on an IMO type.

In addition, the lifecycle of the IBS is presented only conceptually, and a framework with specific components and interfaces for applying the IBS to the network and application management of actual IMOs is insufficient. The present disclosure is also directed to proposing a method of providing a framework with specific components and interfaces that may apply the lifecycle of such an IBS to the management of IMOs.

Objects of the present disclosure are not limited to the above object, and other objects that are not described will be able to be clearly understood by those skilled in the art to which the present disclosure pertains based on the following description.

### Technical Solution

According to one embodiment of the present disclosure, there is provided a method performed by a first device within an intent-based network (IBN) framework, including translating an intent received from a user into a high-level policy, transmitting the high-level policy to a second device, receiving a result of monitoring an operation and/or performance of a service function (SF) from the second device, and analyzing the operation and/or performance of the SF based on the monitoring result.

The high-level policy is i) a network policy (NP) or ii) an application policy (AP), and the SF is performed by the second device based on the high-level policy.

The intent may include a declarative request related to a specific goal of a network.

The intent may include i) an intent input from a user in a natural language format and ii) is translated into the high-level policy based on natural language processing (NLP).

The SF may include i) a network function (NF) and ii) an application function (AF).

The NF may be based on the network policy, and the AF may be based on the application policy.

The NF may an SF related to i) network functions virtualization (NFV) and/or ii) software-defined networking (SDN).

The AF may be an SF performed by one or more applications included in the second device.

The method may further include receiving information on capabilities of the second device from the second device, and translating the intent into the high-level policy based on the information on the capabilities of the second device.

The first device may be a central cloud (CC), and the second device may be a moving object (MO) or an edge cloud (EC).

According to another embodiment of the present disclosure, there is provided a first device including one or more processors, and one or more memories which are connected to the one or more processors and store instructions executed by the one or more processors.

The instructions may translate the intent received from a user into a high-level policy, transmit the high-level policy to a second device, receive a result of monitoring the operation and/or performance of a service function (SF) from the second device, and analyze the operation and/or performance of the SF based on the monitoring result.

The high-level policy may be i) a network policy (NP) or ii) an application policy (AP), and the SF may be performed by the second device based on the high-level policy.

According to another embodiment of the present disclosure, there is provided a method performed by a second device within an intent-based network (IBN) framework, including receiving a high-level policy from the first device, translating the high-level policy into a low-level policy, performing a service function (SF) based on the low-level policy, monitoring an operation and/or performance of the SF, and transmitting the monitoring result to the first device.

The high-level policy is translated into i) a network policy or ii) an application policy based on the intent, and the low-level policy includes a specific rule for a specific SF.

The intent may include a declarative request related to a specific goal of a network.

The intent may include i) an intent input from a user in a natural language format and ii) is translated into the high-level policy based on natural language processing (NLP).

The SF may include i) a network function (NF) and ii) an application function (AF).

The NF may be based on the network policy, and the AF may be based on the application policy.

The NF may an SF related to i) network functions virtualization (NFV) and/or ii) software-defined networking (SDN).

The AF may be an SF performed by one or more applications included in the second device.

The method may further include transmitting information on capabilities of the second device to the first device.

The first device may be a central cloud (CC),
the second device may be a moving object (MO) or an edge cloud (EC).

According to still another embodiment Of the present disclosure, there is provided a second device including one or more processors, and one or more memories which are connected to the one or more processors and store instructions executed by the one or more processors.

The instructions may receive a high-level policy from a first device, translate the high-level policy into a low-level policy, perform the SF based on the low-level policy, monitor an operation and/or performance of the SF, and transmit the monitoring result to the first device.

The high-level policy is translated into i) a network policy or ii) an application policy based on the intent, and the low-level policy includes a specific rule for a specific SF.

### Advantageous Effects

According to the embodiments of the present disclosure, a robust framework that can safely and accurately translate user high-level intents into low-level system configurations can be provided, enabling effective reflection of user intent within the system.

According to the embodiments of the present disclosure, it is possible to solve the problems related to vendor-dependent network policy settings and enhance interoperability between systems, process automation, and ease of policy changes in heterogeneous network environments.

According to the embodiments of the present disclosure, the efficient management of the in-network functions is possible by defining the capabilities of in-network computing functions, registering the in-network computing functions with the controller, and providing standardized data models and interfaces for configuring and monitoring in-network functions according to user intent.

According to the embodiments of the present disclosure, it is possible to resolve difficulties in collecting and analyzing data from various intelligent moving objects and efficiently detect and resolve potential conflicts between multiple user intents. In addition, it is possible to increase the accuracy and efficiency of intent translation by providing the domain knowledge-based natural language processing engine for intent translation according to the types of intelligent moving objects. According to the embodiments of the present disclosure, it is possible to increase the practical applicability of the intent-based systems by providing the framework having specific components and interfaces that can be applied to the lifecycle of the intent-based systems previously presented only conceptually to the network and application management of the intelligent moving objects.

Accordingly, the embodiments of the present disclosure can support efficient orchestration n and management of network and application functions of intelligent moving objects in complex and dynamic digital infrastructure environments, thereby improving the stability and performance of the system.

The effects obtainable from the present disclosure are not limited to the above effects, and other effects that are not described will be able to be clearly understood by those skilled in the art to which the present disclosure pertains based on the following description.

### DESCRIPTION OF DRAWINGS

The accompanying drawings, which are included as part of the detailed description to help understanding of the present disclosure, provide embodiments of the present disclosure and describe the contents of the present disclosure together with the detailed description, in which:

FIG. 1 shows an example of a lifecycle of an intent-based system;

FIG. 2 shows an example of an interface to in-network computing functions (I2ICF) framework according to an embodiment of the present disclosure;

FIG. 3 shows an example of an edge cloud according to the embodiment of the present disclosure;

FIG. 4 shows an example of a framework for a moving object (MO) of the I2ICF according to the embodiment of the present disclosure;

FIG. 5 shows an example of a framework for an intelligent moving object (IMO) of the I2ICF according to the embodiment of the present disclosure;

FIG. 6 shows an example of the operational sequence of a framework for an IMO;

FIG. 7 shows an example of a framework for an edge cloud of the I2ICF according to the embodiment of the present disclosure;

FIG. 8 is a flowchart for describing a method according to one embodiment of the present disclosure;

FIG. 9 is a flowchart for describing a method according to another embodiment of the present disclosure; and

FIG. 10 is a view showing the configuration of devices according to an embodiment of the present disclosure.

### DETAILED DESCRIPTION OF THE INVENTION

Hereinafter, embodiments of the present disclosure will be described in detail with reference to the drawings. However, the detailed descriptions of known functions or components that can obscure the gist of the embodiments in the following descriptions and the accompanying drawings will be omitted. In addition, throughout the specification, when a certain portion “includes” a certain component, it means that the certain portion may further include the other component rather than precluding the other component unless specifically stated to the contrary.

The terms used in the present disclosure are only used to describe specific embodiments and are not intended to limit the present disclosure. The singular includes the plural unless the context clearly dictates otherwise. In the present application, it should be understood that the term “include” or “have” is intended to specify that a feature, a number, a step, an operation, a component, a part, or a combination thereof is present, but does not preclude the possibility of the presence or addition of one or more other features, numbers, steps, operations, components, parts, or combinations thereof in advance.

Unless especially defined otherwise, all terms used herein, including technical or scientific terms, have the same meaning as commonly understood by those skilled in the art to which the present disclosure pertains. The terms defined in a generally used dictionary should be construed as having meanings that coincide with the meanings of the terms from the context of the related technology and are not construed as an ideal or excessively formal meaning unless clearly defined in this document.

In the present disclosure, the term “A or B” may mean “only A,” “only B,” or “both A and B.” That is, in the present disclosure, “A or B” may be construed as “A and/or B.” For example, in the present disclosure, “A, B, or C” may mean “only A,” “only B,” “only c,” or “any combination of A, B, and C.”

A slash (/) or a comma used herein may mean “and/or.” For example, “A/B” may mean “A and/or B.” Accordingly, “A/B” may mean “only A,” “only B,” or “both A and B.” For example, “A, B, C” could mean “A, B, or C.”

### Intent-Based System (IBS)

In today's complex and dynamic digital infrastructure, particularly in cloud and edge computing environments in which network softwareization is widely applied, providing efficient system management and automated service is becoming increasingly important. In these environments, there is a need for a new approach to effectively reflect user or administrator preferences within the system.

In order to fulfill such need, an IBS paradigm has emerged. The IBS is a system that allows users or administrators to declaratively define high-level intents the system should achieve without explicitly specifying the detailed methods for achieving or implementing the intents. The user intent may be represented by a natural language (NL) and translated into policies (e.g., network policies and application policies) using natural language processing (NLP). The IBS translates these user intents into specific network configurations and policies, enabling dynamic provisioning, fault tolerance, and automated quality of service (QoS) control, etc. In addition, the IBS uses artificial intelligence and machine learning technologies to enhance decision-making processes and make infrastructure management more efficient. A robust framework is essential to safely and accurately translate these high-level intents into executable low-level configurations of actual systems. In order to understand how the IBS actually operates, the lifecycle of the IBS will be described below.

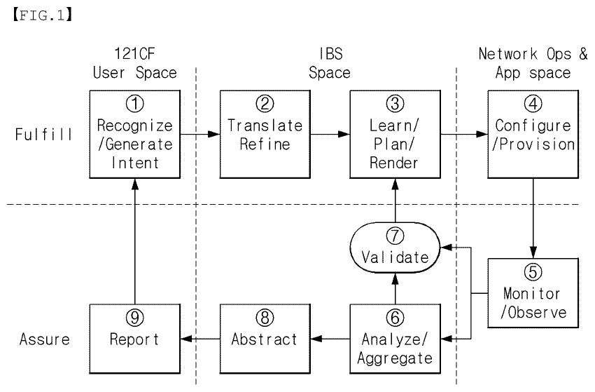

FIG. 1 shows an example of the lifecycle of the IBS.

Referring to FIG. 1, the lifecycle of the IBS may be divided into three areas: a) i) an IBS user space, ii) an IBS space, and iii) a network ops & app space and may also be divided into two areas: b) i) a “Fulfill” area in which intentions are generated and operations are performed based on the intents, and ii) an “Assure” area in which the performed operations are evaluated, modified, and reported.

Hereinafter, each stage of the lifecycle of the IBS will be described sequentially.

### 1. Intent Recognition/Generation Stage

An IBS user recognizes or generates an intent requesting a network service based on text or voice input and transmits the generated intent to an IBS controller. In this case, the intent is a set of goals and deliverables that declaratively define operational goals that a network should fulfill and deliverables that the network should provide without specifying a method of achieving or implementing the operational goals and the deliverables.

### 2. Translation/Refinement Stage

The IBS controller may process the user intent and translates the user intent into a policy necessary for system configuration and control. The IBS controller translates the intent received in this stage into a policy understandable by a service function (SF) responsible for executing a network service.

### 3. Leaning/Planning/Execution Stage

Based on the translated policy, the IBS controller selects an appropriate SF to perform the network service and transmits the policy to the SF.

### 4. Configuration/Provisioning Stage

The SF may include a virtual network function (VNF), a cloud native network function (CNF), and/or a physical network function (PNF) for specific services. The SFs in the intent-based system network that receive the policy perform the necessary configuration and execute the requested service according to the policy.

Stages 1 to 4 may be included in an intent fulfillment area.

### 5. Monitoring/Observation Stage

SFs generate monitoring data about their operations and transmit the monitoring data to an analyzer for monitoring and analysis purposes.

### 6. Analysis/Aggregation Stage

The IBS analyzer receives monitoring data from the SFs, analyzes the data using artificial intelligence (AI) or machine learning algorithms, and aggregates the network-wide observation results. In the I2ICF framework according to the embodiment of the present disclosure, the IBS analyzer may be referred to as an I2ICF Analyzer.

### 7. Validation Stage

A validator verifies whether the SFs are properly providing the intended services based on the analysis result.

### 8. Abstraction Stage

An abstractor processes feedback or modified policies and translates the feedback or modified policies into a simplified and human-readable format for a reporter to transmit to IBS users.

### 9. Reporting Stage

The reporter receives abstracted information and generates a report for the IBS user based on the abstracted information. The user uses this report to improve or supplement the original intent, which then restarts the cycle from Stages 1 to 8 to form a closed-loop intent cycle. This closed-loop intent cycle uses automation, machine learning, and user feedback to ensure that the IBS continuously adapts to changing conditions and user requirements.

Stages 5 to 9 may be included in an intent assure area.

framework is required to safely and accurately translate these high-level user intents into executable low-level configurations of an actual system. The present disclosure proposes an interface to in-network computing functions (I2ICF) framework for this purpose.

### Interface to Network Security Function (I2NSF)

The I2ICF may be built on the I2NSF architecture. The I2NSF is a framework standardized by the Internet Engineering Task Force (IETF). The primary purpose of the I2NSF is to provide a standardized interface for controlling and managing network security services through network security functions (NSFs).

Prior to the advent of I2NSF, security policy setting generally relied on vendor-specific tools and interfaces, hindering interoperability, process automation, and ease of policy change in heterogeneous network environments. Early approaches such as policy-based management (PBM) and OpenFlow-based firewalls also lacked a standardized method of defining high-level security rules or consistently applying the corresponding rules across various security tools, such as firewalls, intrusion detection systems (IDSs), and deep packet inspection systems.

The emergence of network functions virtualization (NFV) and software-defined networking (SDN) has further emphasized the need for centralized and automated control of security infrastructure. In order to address these challenges, the I2NSF introduces standardized mechanisms, such as a YANG-based data model and RESTCONF/NETCONF interfaces, to support the specification, translation, and enforcement of security policies.

The purpose of the I2ICF framework according to the embodiments of the present disclosure is to extend beyond security functions to encompass a broader range including application functions (AF) and network functions (NF), thereby defining a common control and management framework for intelligent services. In addition, the security considerations of the I2ICF framework are the same as those of the I2NSF framework.

### Interface to In-Network Computing Functions (I2ICF)

The I2ICF is a computing in the network (COIN) program group for providing necessary computing tasks and functions and may include i) in-network network functions and ii) in-network application functions. In the present disclosure, for convenience of description, the in-network computing function may be referred to as an in-network function.

The in-network network function is defined in the context of the NFV and SDN and may include functions that perform computing tasks in the network infrastructure.

The in-network application function is a service function for applications within an MO and may be a COIN program group that provides the necessary application tasks and functions. The MO is a movable object having its own power source and wireless communication capabilities, and in the context of the 5G vehicle-to-everything (V2X) environment, the MO may be an Internet of Things (IoT) device, an SDV, an unmanned aerial vehicle (UAV), or a drone. In addition, in the present disclosure, the MO may include an intelligent MO (IMO).

The I2ICF framework defines components and interfaces for configuring and monitoring user services composed of the in-network computing functions.

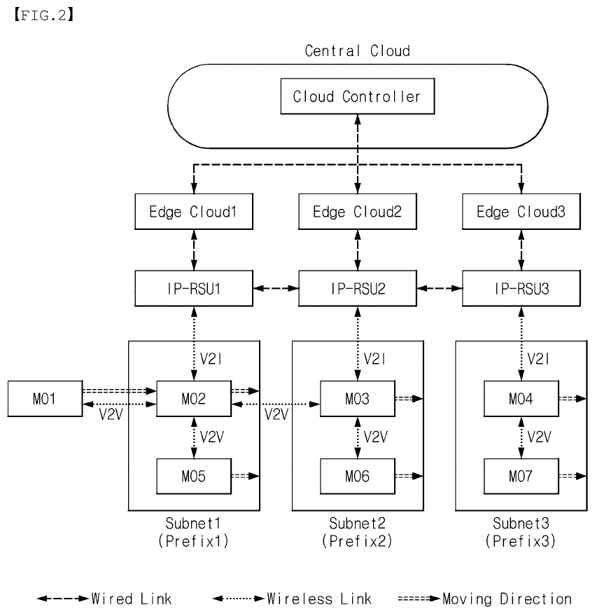

FIG. 2 shows an example of an I2ICF framework according to an embodiment of the present disclosure.

Referring to FIG. 2, a schematic diagram of the I2ICF framework including wireless and wired networks within a central cloud (CC) is shown.

The framework includes the CC at the top layer, and the CC includes a cloud controller. The CC is connected to multiple edge-clouds Edge Cloud 1, Edge Cloud 2, and Edge Cloud 3 (see FIG. 2) via wired links (<---->). Each edge cloud is connected to one or more IP-roadside units (IP-RSUs) IP-RSU1, IP-RSU2, and IP-RSU3 (see FIG. 2) via wired links, and the IP-RSUs may also be connected via wired links.

The IP-RSUs are connected to multiple MOs MO1 to MO7 (see FIG. 2) via wireless links (< . . . >). In this case, the wireless links may be connected via vehicle-to-infrastructure (V2I) communication.

In addition, the MOs may be connected via wireless links. In this case, the wireless links may be connected via vehicle-to-vehicle (V2V) communication.

The MOs may move in a moving direction (===>) as shown. Each MO group may belong to subnets Subnet 1 (Prefix 1), Subnet 2 (Prefix 2), and Subnet 3 (Prefix 3) (see FIG. 2).

The I2ICF framework defines interfaces for in-network computing functions for user services at both network and application levels and configures and monitors the in-network computing functions that implement applications and services in addition to components and interfaces. The in-network computing functions may include i) in-network network functions defined in the context of the NFV and the SDN, and ii) in-network application functions that appear in the context of MOs. The MO may be a movable object having its own power source and wireless communication capabilities. For example, the MOs may include IoT devices, SDVs, UAVs, and drones. In addition, the MOs may correspond to programmable network devices (PNDs) that may be reconfigured according to different network requirements within the MO. An intent-based management strategy that enables automatic configuration of the MOs is required between the CC and the MOS.

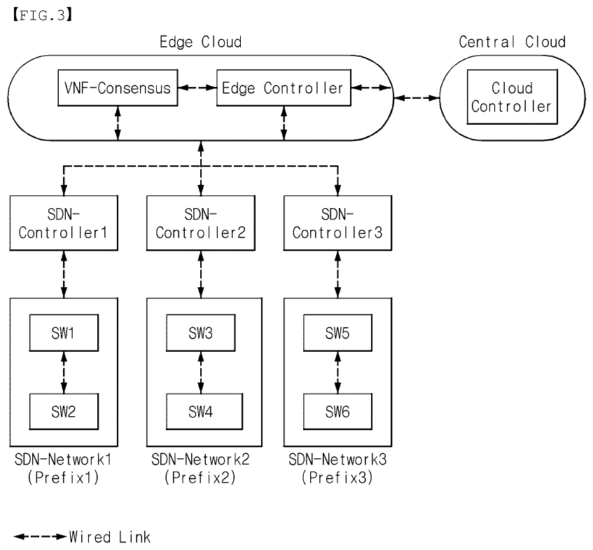

FIG. 3 shows an example of an edge cloud according to the embodiment of the present disclosure.

Referring to FIG. 3, the VNF-consensus architecture of the I2ICF framework within the edge cloud including the CC is shown. The framework is composed of a CC and an edge cloud.

The CC includes a cloud controller, which is connected to the edge cloud via a wired link (<---->). The edge cloud includes a VNF-consensus component and an edge controller, and the edge controller is connected to multiple SDN controllers SDN-Controller1, SDN-Controller2, and SDN-Controller3 (see FIG. 3) via wired links. Each SDN controller is connected to one or more switches via wired links. The switches form an SDN network.

The VNF-consensus architecture within the edge cloud enables the synchronization of flow table information of all replicated SDN controllers within the same edge cloud. The edge cloud may be comprised of the edge controller, an edge analyzer, a vendor management system (VMS), and SFs. The edge controller serves as an edge cloud administrator, and the edge analyzer monitors and analyzes the data of the edge cloud. For example, the SFs for the edge cloud may be network functions. Specifically, the network functions may include i) VNF consensus, ii) an NFV failure detector, and iii) NFV reliable-ordered broadcast (NFV-RBCast). The I2ICF framework may be presented as an example of an intent-based system for an edge cloud.

### I2ICF Framework for MO

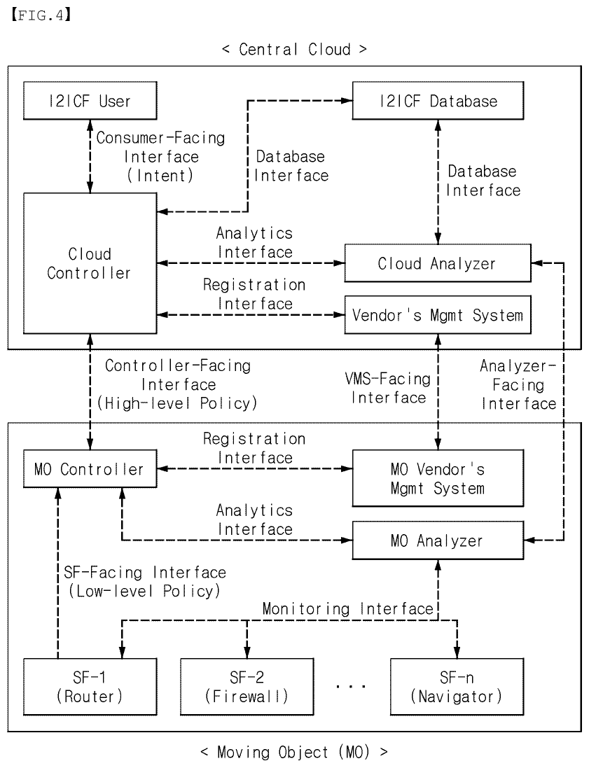

FIG. 4 shows an example of a framework for the MO of the I2ICF according to the embodiment of the present disclosure. Referring to FIG. 4, an IBS instance of the I2ICF framework for an MO is shown.

The framework is composed of a CC and an MO.

The CC includes an I2ICF user, an I2ICF database, a cloud controller, a cloud analyzer, and a VMS.

The I2ICF user is software (e.g., a web browser-based user interface) used by the I2ICF administrator to communicate network intent to an MO controller.

The I2ICF database is the primary repository for in-network function management and monitoring information and manages information including the network and security configuration and state of the MO. For example, the I2ICF database maintains a current position and navigation route of an MO (e.g., an SDV).

The cloud controller is the primary component that manages and controls other system components of the CC and includes a security function. The cloud controller serves as an orchestrator for the CC. The cloud controller may translate the intent of the I2ICF user into high-level policies and transmit these high-level policies to the MO controller.

The cloud analyzer is a component that collects and evaluates monitoring data from the MO analyzer to ensure the functions and performance of service functions and is similar to a network data analytics function (NWDAF) of a 5G network.

The VMS provides an image of a virtualized SF for a cloud service and registers the corresponding SF and access information with the cloud controller.

The MO includes an MO controller, an MO analyzer, a moving object VMS (MOVMS), and SFs.

The MO controller controls and manages other components of the MO framework, translates high-level policies received from the cloud controller into low-level policies that SFs may understand, and transmits the low-level policies to the SFs.

The MO analyzer collects and analyzes monitoring data from the SFs of the MO to monitor the activity and performance of the SFs. For example, when an issue occurs in the MO network (e.g., a security attack, traffic congestion, or service quality degradation), the MO analyzer may request policy reconfiguration or feedback from the MO controller to restore security or resolve the network issue.

The MOVMS provides the MO framework with an image of a virtualized SF for the MO service and registers the function and SF access control information with the MO controller.

The SF may be a virtual network function, a cloud-native network function, or a physical network function for a specific service. The SFs for an MO may include network functions and application functions. The network functions may include functions such as a router, a firewall, etc. In addition, the application functions may include functions such as a navigator and the like.

Referring to FIG. 4, various interfaces are defined between components within the framework.

A consumer-facing interface is used to communicate an intent between the I2ICF user and the cloud controller.

A database interface is used to exchange data between the I2ICF database and the cloud controller and between the I2ICF database and the cloud analyzer.

An analytics interface is used for reconfiguration or feedback transmission of policies generated from the result of analyzing SF monitoring data between the MO analyzer and the MO controller or between the cloud analyzer and the cloud controller.

A registration interface is used to transmit information for registering functions of SFs and access control information to the cloud controller or the MO controller.

A controller-facing interface is used to transmit high-level policies corresponding to translated intents between the cloud controller and the MO controller.

A VMS-facing interface is used to exchange SF feature information, such as SF container images, between a cloud VMS and an MO VMS.

An analyzer-facing interface is used to exchange security, network, and system-related analysis information for SFs between the MO analyzer and the cloud analyzer.

An SF-facing interface is used to transmit translated low-level policies between the MO controller and the SFs.

A monitoring interface is used to collect SF monitoring data between the SF and the MO analyzer to identify security, system, and network issues related to the SF.

In the I2ICF framework, the intents received from the I2ICF users are translated into corresponding high-level policies by an intent translator within the cloud controller in the CC. The high-level policy may be translated into a corresponding low-level policy by a policy translator within the MO controller. The translated low-level policy is transmitted from the MO controller to the appropriate SF within the MO, and the MO analyzer monitors and analyzes the activity and performance of the SF. If necessary, the MO analyzer may augment rules in the high-level or low-level network policy or automatically generate and configure new rules and transmit the rules to the appropriate SF.

### I2ICF Framework for Intelligent MO

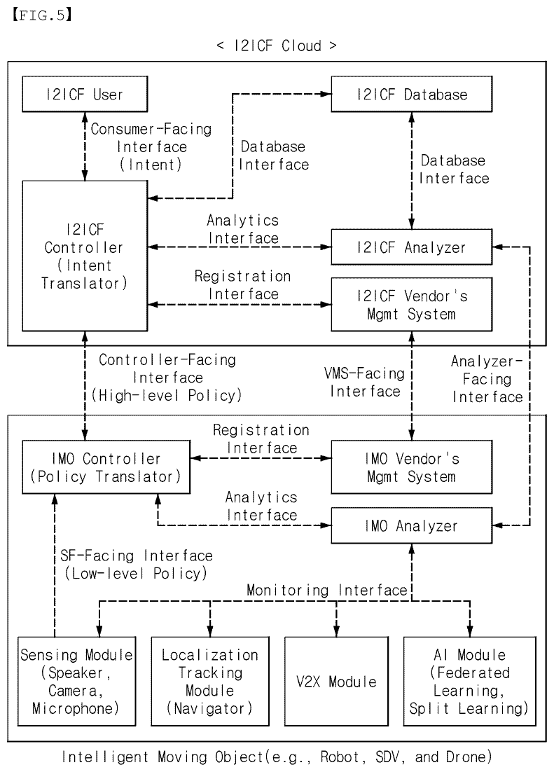

FIG. 5 shows an example of a framework for an IMO of the I2ICF according to the embodiment of the present disclosure.

Referring to FIG. 5, the I2ICF framework may include i) an I2ICF cloud and ii) an IMO.

The I2ICF cloud may serve as the central management and control unit of the IBS. In this case, the I2ICF cloud may correspond to the CC of FIGS. 2 to 4. For example, the I2ICF cloud may include i) an I2ICF user, ii) an I2ICF controller, iii) an I2ICF database, iv) an I2ICF analyzer, and v) an I2ICF VMS.

The I2ICF user is software (e.g., a web-based user interface) used by a network administrator to transmit network intent to the framework.

The I2ICF controller is a component that translates user intent into high-level policies (e.g., network function (NP) policies or application (AP) policies) and manages other system components and may interact with the IMO controller through the controller-facing interface. The I2ICF controller may include an intent translator, and the intent translator may translate the intent into the high-level policies.

The I2ICF database is a database that manages data including network and security configurations, position data, etc.

The I2ICF analyzer may collect and evaluate monitoring data from IMOs and provide reconfiguration feedback to the I2ICF controller to ensure the performance and functions of the SFs.

The I2ICF VMS may register service modules and resources with the I2ICF controller.

The IMO may perform actual computing and application tasks. For example, the IMO may be composed of i) an IMO controller, ii) an IMO VMS, iii) an IMO analyzer, and iv) SFs.

The IMO controller may manage IMO modules and translate high-level policies received from the I2ICF controller into low-level policies that the SFs may understand and execute. The IMO controller may include a policy translator, and the policy translator may translate the high-level policies into low-level policies.

The IMO VMS may register IMO modules with the IMO controller.

The IMO analyzer may collect monitoring data from IMO modules and analyze their performance to ensure functionality.

The SF is a component that performs specific application tasks within an IMO. Referring to FIG. 5, the SF may include i) a sensing module such as a speaker, a camera, a microphone, or the like, ii) a localization tracking module such as a navigator or the like, iii) a V2X module that performs data exchange between IMOs and roadside infrastructure (vehicle-to-infrastructure (V2I)), other vehicles (V2V), pedestrians (vehicle-to-pedestrian (V2P)), and remote networks (vehicle-to-network (V2N)), and iv) an AI module that performs AI functions such as data processing, analysis, prediction, etc.

Each component within the I2ICF framework may communicate with other components through preset or predefined interfaces. For example, the preset or predefined interfaces may include the following interfaces:
The consumer-facing interface is an interface between the I2ICF user and the I2ICF controller and is used to transmit intents to the I2ICF controller.
The controller-facing interface is an interface between the I2CIF controller and the IMO controller and is used to transmit high-level policies corresponding to translated intents.
The SF-facing interface is an interface between the IMO controller and the IMO module (i.e., the SF) and may be used to transmit low-level policies.
The registration interface is an interface between the controller and the VMS and may be used to transmit the capabilities and access control information of the SF for SF registration.
The monitoring interface is an interface between the SF and the IMO analyzer and may be used to collect SF monitoring data and identify security or network issues related to the SF.
The analytics interface is an interface for transmitting reconfiguration policies and feedback between the analyzer and the controller.
The analyzer-facing Interface is an interface between the I2ICF analyzer and the IMO analyzer and may be used to transmit network, security, and system-related analysis results for the SF.
The VMS-facing interface is an interface between VMSs and may be used to exchange SF information.
The database interface is an interface between the I2ICF database and the I2ICF analyzer and may be used to exchange data in the I2ICF database.
The I2ICF cloud is an intent-based management framework and may provide a function for software maintenance and network and cybersecurity configuration. The I2ICF cloud may be distributed as an I2ICF or an I2ICF edge cloud depending on the network architecture and service requirements.

Meanwhile, the I2ICF for applications within the IMO may be considered.

The IBS may orchestrate various applications within the IMO. This can facilitate integrated control of multiple service modules, thereby improving cohesive operation and adaptability in diverse mobility environments.

The applications within the IMO may be SFs of the I2ICF. For example, the SFs may include i) a sensing module, ii) a position tracking module, iii) a V2X module, and iv) an AI module.

An IMO may make autonomous decisions, such as acceleration, deceleration, stopping, and initiating specific functions, based on sensor-based environmental data (e.g., audio input, visual recognition), according to system-level policies. For example, the sensing module may include a speaker, a camera, and a microphone.

The position tracking module may calculate an optimal route within a transportation network to effectively guide an MO. Real-time data analysis can be used to optimize mobility efficiency, minimize delays, and avoid congested or hazardous areas. For example, the position tracking module may include a navigator.

The V2X module may be embedded in an IMO and may exchange data with roadside infrastructure (V2I), other vehicles (V2V), pedestrians (V2P), and remote networks (V2N).

The AI module may perform AI functions such as data processing, analysis, and prediction. The AI module may understand the surrounding environment, may be optimized for specific tasks based on federated learning or split learning, and integrated into various systems.

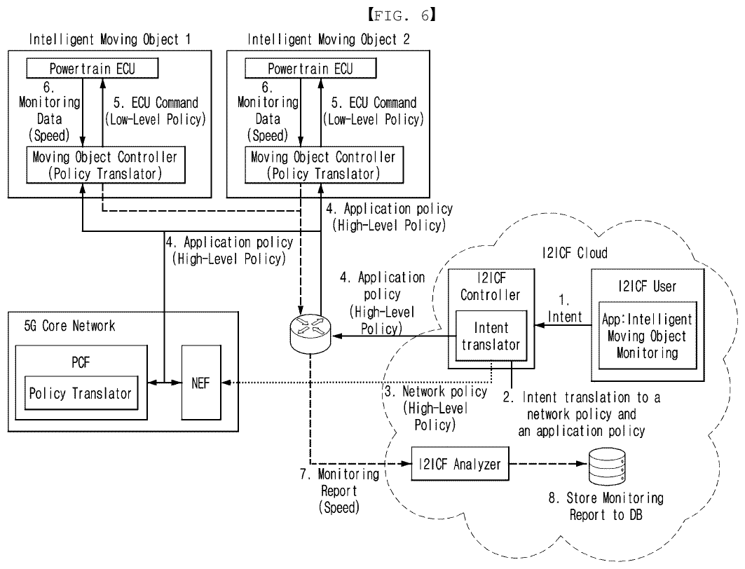

FIG. 6 shows an example of the operational sequence of a framework for an IMO.

Referring to FIG. 6, the framework includes an I2ICF cloud and one or more IMOs. The I2ICF cloud may include an I2ICF user, an I2ICF controller, and an I2ICF analyzer, and the IMO may include an MO controller.

A workflow of the framework begins when the I2ICF user (e.g., an administrator) transmits an intent to the I2ICF controller (Stage 1).

The intent translator of the I2ICF controller interprets the intent and generates corresponding high-level policies (e.g., network policies and application policies) (Stage 2).

The translated high-level network policies may be transmitted to a 5G core network (Stage 3).

The 5G core network may be connected to one or more IMOs and may include a network exposure function (NEF) and a policy control function (PCF).

For example, the PCF may include a policy translator.

The high-level network policies may be transmitted to the NEF within the 5G core network. Then, the high-level network policies may be transmitted to the PCF, and the PCF may translate the high-level network policies into low-level network policies through the policy translator. The translated low-level network policies may be transmitted to the appropriate network function and/or security function, allowing the 5G core network to perform the requested network and/or security services.

The translated high-level application policy defining the configuration of the IMO may be transmitted to the MO controller having the policy translator (Stage 4). In this case, the translated high-level application policies may be transmitted to one or more IMOs via a router.

Each MO controller may apply the received application policy to a powertrain electronic control unit (ECU) and modify operating parameters of each MO accordingly (Stage 5).

The IMO may continuously track its operating state (e. g., a direction, a speed) and transmit operational information to the MO controller (Stage 6).

The MO controller may summarize the collected information into a monitoring report and transmit the monitoring report to the I2ICF analyzer (Stage 7).

The I2ICF analyzer may review the monitoring report to evaluate the effectiveness of the applied policy. The I2ICF analyzer may store the operational data in a database for subsequent analysis (Stage 8).

This intent-based management system may operate as a closed-loop mechanism.

### I2ICF Framework for Edge Cloud

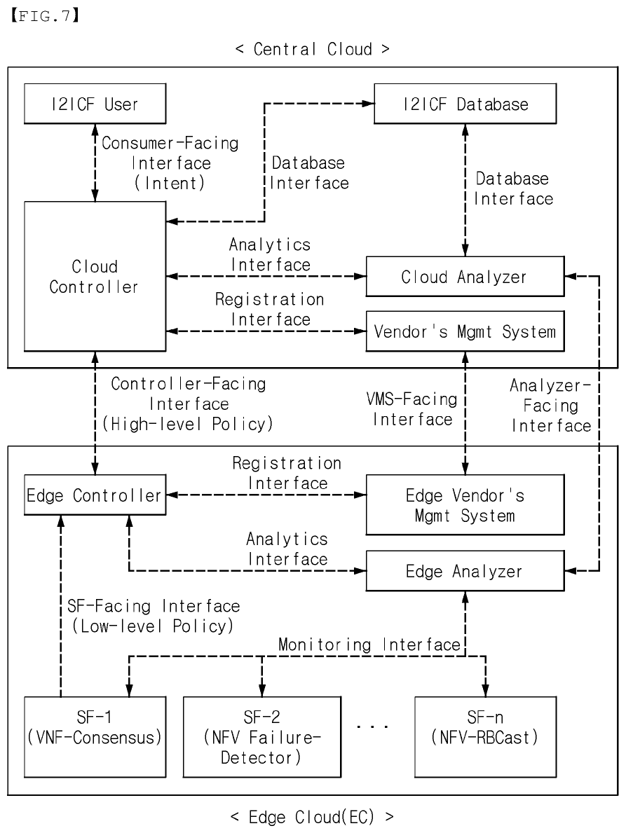

FIG. 7 shows an example of a framework for an edge cloud (EC) of the I2ICF according to the embodiment of the present disclosure. Referring to FIG. 7, the IBS instance of the I2ICF framework for the EC is shown. The framework is composed of a CC and an EC.

The CC may include an I2ICF user, an I2ICF database, a cloud controller, a cloud analyzer, and a VMS.

The I2ICF user is software (e.g., a web browser-based user interface) used by the I2ICF administrator to transmit network intent to the edge controller.

The I2ICF database is the primary repository for in-network function management and monitoring information and manages information including the network and security configuration and state of the EC.

The cloud controller is the primary component that manages and controls other system components of the CC, includes security functions, and serves as an orchestrator for the CC.

The cloud analyzer is a component that collects and evaluates monitoring data from the edge analyzer to ensure the functions and performance of the SFs and is similar to a network data analytics function (NWDAF) of 5G networks. The VMS provides an image of a virtualized SF for a cloud service and registers the corresponding SF and access information with the cloud controller.

The edge cloud may include the edge controller, the edge analyzer, an edge VMS, and the SFs.

The edge controller may control and manage other components of the edge cloud framework, translate high-level policies received from the cloud controller into low-level policies that the SFs may understand and transmit these policies to the SFs.

The edge analyzer may collect and analyze monitoring data from the SFs in the edge cloud and monitor the activities and performance of the SFs.

When an issue occurs in the edge cloud network (e.g., a security attack, traffic congestion, or service quality degradation), the edge analyzer may request policy reconfiguration or feedback information from the edge controller to restore security or resolve the network issue.

The edge VMS may provide images of virtualized SFs for edge cloud services to the edge cloud framework and register function and service function access control information with the edge controller.

The SFs of the edge cloud may include i) a virtual network function for a specific service, ii) a cloud-native network function, and iii) a physical network function. The SFs for the edge cloud may include network functions (NFs) such as VNF-consensus, an NFV failure detector, and an NFV-RBCast.

Various interfaces are defined between components within the I2ICF framework.

The consumer-facing interface is used for intent communication between the I2ICF users and the cloud controller.

The database interface is used to exchange data between the I2ICF database and the cloud controller and between the I2ICF database and the cloud analyzer.

The analytics interface is used for reconfiguration or feedback transmission of policies generated from the result of analyzing SF monitoring data between the edge analyzer and the edge controller or between the cloud analyzer and the cloud controller.

The registration interface is used to transmit information for registering functions of SFs and access control information to the cloud controller or the edge controller. This interface may be an interface between the cloud controller and the cloud VMS or between the edge controller and the edge VMS.

The controller-facing interface is used to transmit high-level policies corresponding to translated intents between the cloud controller and the edge controller.

The VMS-facing interface is used to exchange SF feature information, such as SF container images, between the cloud VMS and the edge VMS.

The analyzer-facing interface is used to exchange security, network, and system-related analysis information for SFs between the edge analyzer and the cloud analyzer.

The SF-facing interface is used to transmit translated low-level policies between the edge controller and the SFs.

The monitoring interface is used to collect SF monitoring data between the SF and the edge analyzer to identify security, system, and network issues related to the SF.

In the I2ICF framework, the intents received from the I2ICF users are translated into corresponding high-level policies by the intent translator within the cloud controller of the CC. The high-level policy may be translated into a corresponding low-level policy by a policy translator within the edge controller of the EC. The translated low-level policy may be transmitted from the edge controller to the appropriate SF within the EC, and the edge analyzer monitors and analyzes the activities and performance of the SFs. If necessary, the edge analyzer may augment rules in the high-level or low-level network policy or automatically generate and configure new rules and transmit them to the appropriate SF. The intents, high-level policies, and low-level policies may be written in XML or YAML documents and transmitted to target components using an NETCONF, RESTCONF, or REST API.

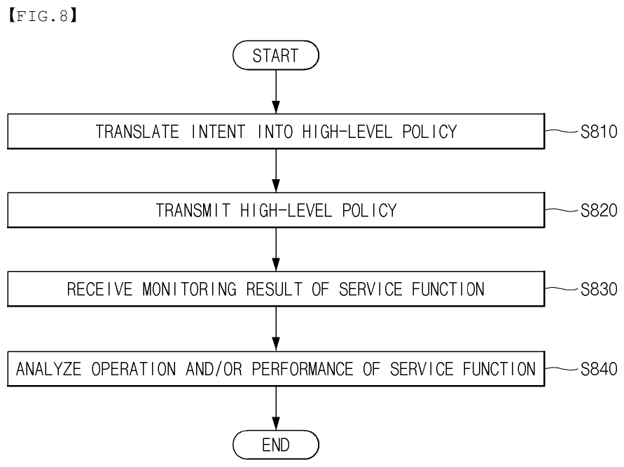

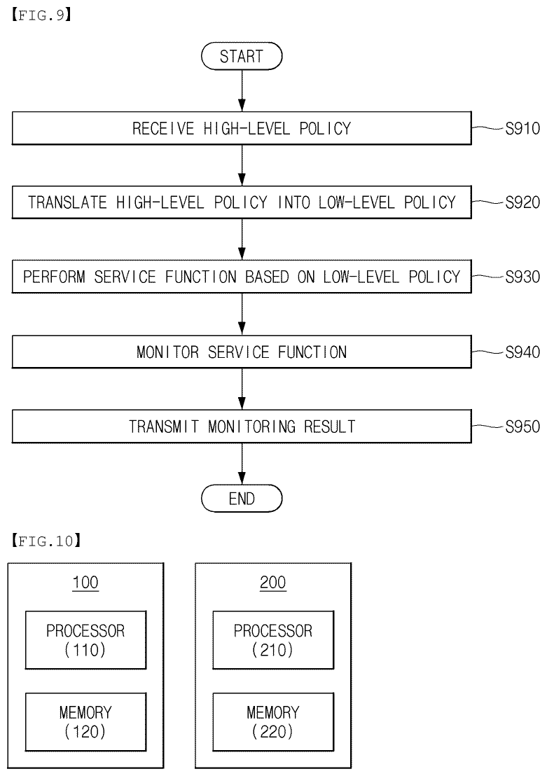

Hereinafter, the above embodiments will be described in detail with reference to FIGS. 8 and 9 in terms of the operation of a first device (e.g., a CC) and a second device (e.g., an EC, an MO, an IMO). Methods to be described below are distinguished for convenience of description, and it is apparent that some components of one method may be substituted with or combined with some components of the other method.

FIG. 8 is a flowchart for describing a method according to one embodiment of the present disclosure.

Referring to FIG. 8, a method performed by the first device in an intent-based network (IBN) framework according to one embodiment of the present disclosure includes an operation S810 of translating an intent received from a user into a high-level policy, an operation $820 of transmitting the high-level policy to a second device, an operation S830 of receiving a monitoring result of the operation and/or performance of a SF from the second device, and an operation S840 of analyzing the operation and/or performance of the SF based on the monitoring result.

In the operation S810, the first device translates the intent received from the user into the high-level policy. In this case, the high-level policy is either i) a network policy (NP) or ii) an application policy (AP).

According to one embodiment, the intent may include a declarative request related to a specific goal of a network.

For example, the intent may be a set of goals and deliverables that declaratively define operational goals that the network should fulfill and deliverables that the network should provide without specifying a method of achieving or implementing the operational goals and the deliverables to be provided and the like.

According to one embodiment, the intent may include an intent input by a user in an NL format.

For example, the first device may recognize and/or generate the intent based on text and/or voice input received from the user.

For example, the intent may be recognized and/or generated by an IBS user (or an I2ICF user) of the first device.

According to one embodiment, the intent may be translated into the high-level policy based on NLP.

According to one embodiment, the intent may be translated into the high-level policy by an IBS controller (or an I2ICF controller) of the first device.

For example, the IBS controller (or cloud controller/I2ICF controller) may include an intent translator, and the intent translator may translate the intent into the high-level policy.

According to one embodiment, the intent may be received via a consumer-facing interface.

In the operation S820, the first device transmits the high-level policy to the second device.

According to one embodiment, the high-level policy may be transmitted to the second device by the IBS controller (or cloud controller/I2ICF controller) of the first device.

According to one embodiment, the high-level policy may be transmitted to the second device via a controller-facing interface.

In the operation S830, the first device receives a result of monitoring the operation and/or performance of an SF from the second device. In this case, the SF is performed by the second device based on the high-level policy.

According to one embodiment, the monitoring result may be received by an IBS analyzer (or I2ICF analyzer) of the first device.

According to one embodiment, the monitoring result may be received via an analyzer-facing interface.

For example, the SF may include a VNF, a CNF, and/or a PNF of a specific service.

According to one embodiment, the SF includes i) an NF and ii) an AF.

According to one embodiment, the NF may be based on the network policy, and the AF may be based on the application policy.

The NF may be an SF related to i) NFV and/or ii) SDN.

As a specific example, the NF (or in-network function) is defined in the context of the NFV and the SDN and may include functions that perform computing tasks in the network infrastructure.

For example, the AF may be an SF performed by one or more applications included in the second device.

As a specific example, the AF (or network application function) is an SF for an application within an MO and may be a COIN program group that provides necessary application tasks and functions.

As a specific example, the MO is a movable object with its own power source and wireless communication capabilities and in the context of a 5G V2X environment, the MO may include IoT devices, SDVs, UAVs, and/or drones and include IMOs.

According to one embodiment, based on the second device being an MO (or an IMO), i) the NF may include functions such as a router, a firewall, and the like, and ii) the AF may include functions such as a navigator and the like.

According to another embodiment, based on the second device being an EC, the NF may include i) VNF-consensus, ii) an NFV failure detector, and iii) an NFV-RBCast.

In the operation S840, the first device analyzes the operation and/or performance of the SF based on the monitoring result.

According to one embodiment, the analysis may be performed by an IBS analyzer (or I2ICF analyzer) of the first device.

According to one embodiment, the method may further include receiving information on the capabilities of the second device from the second device and converting the intent into the high-level policy based on the information on the capabilities of the second device.

For example, the first device may receive the information on the capabilities of the second device from the second device before translating the intent into the high-level policy.

Thereafter, the first device may generate an appropriate high-level policy for the second device by translating the intent into the high-level policy based on the information on the capabilities of the second device, thereby improving the performance of the SFs of the second device.

According to one embodiment, the first device may be a CC, and the second device may be an MO or an EC.

The operations S810 to S840 may be implemented by devices of FIG. 10. For example, referring to FIG. 10, a first device 100 may control one or more processors 110 and/or one or more memories 120 to perform the operations S810 to S840.

Hereinafter, the above embodiments will be described in detail in terms of the operation of the second device.

Operations S910 to S950, which will be described below, may correspond to the operations S810 to S840 described in FIG. 8, and the overlapping descriptions will be omitted in consideration of the corresponding relationship. The detailed description of the operation of the second device, which will be described below, may be replaced with the corresponding description/embodiment of FIG. 8.

FIG. 9 is a flowchart for describing a method according to another embodiment of the present disclosure.

Referring to FIG. 9, a method performed by a second device in an IBN framework according to another embodiment of the present disclosure includes an operation S910 of receiving a high-level policy from a first device, an operation of S920 of translating the high-level policy into a low-level policy, and operation S930 of performing an SF based on the low-level policy, an operation S940 of monitoring the operation and/or performance of the SF, and an operation S950 of transmitting the monitoring result to the first device.

In the operation S910, the second device receives the high-level policy from the first device. In this case, the high-level policy is translated into i) a network policy or ii) an application policy based on the intent.

According to one embodiment, the high-level policy may be received by a controller of the second device. For example, the controller of the second device may be i) an MO controller, an IMO controller, or iii) an EC controller.

According to one embodiment, the high-level policy may be received through a controller-facing interface.

In the operation S920, the second device translates the high-level policy into a low-level policy. In this case, the low-level policy includes specific rules for specific SFs.

For example, the low-level policy may be a specific rule that the SF may understand.

According to one embodiment, the high-level policy may be translated by the controller of the second device.

For example, the controller of the second device may include a policy translator, and the policy translator may translate the high-level policy into the low-level policy.

In the operation S930, the second device performs an SF based on the low-level policy.

According to one embodiment, the low-level policy may be transmitted from the controller of the second device to the appropriate SF of the second device.

In the operation S940, the second device monitors the operation and/or performance of the SF.

According to one embodiment, the monitoring may be performed by an analyzer of the second device. For example, the analyzer of the second device may be i) an MO analyzer, ii) an IMO analyzer, or iii) an EC analyzer.

According to one embodiment, the analyzer of the second device may analyze the operation and/or performance of the SF.

For example, the analyzer of the second device rules may augment the rules of the high-level or low-level network policy or automatically generate and configure new rules and transmit the rules to the appropriate SF.

In the operation S950, the second device transmits the monitoring result to the first device.

According to one embodiment, the monitoring result may be transmitted by the controller of the second device.

According to one embodiment, the monitoring result may be transmitted via an analytics interface.

The operations S910 to S950 may be implemented by the devices of FIG. 10. For example, referring to FIG. 10, a second device 200 may control one or more processors 220 and/or one or more memories 220 to perform the operations S910 to S950.

Hereinafter, a device to which the embodiments of the present disclosure may be applied (device for implementing a method/operation according to the embodiments of the present disclosure) will be described with reference to FIG. 10.

FIG. 10 is a view showing the configuration of devices according to an embodiment of the present disclosure.

Referring to FIG. 10, the first device 100 may include the processor 110 and the memory 120.

The processor 110 of the first device 100 may be configured to implement the operation of the first device in the embodiments described herein.

The memory 120 of the first device 100 may be connected to the processor 110 and store instructions executed by the processor 110.

The second device 200 may include a processor 210 and a memory 220.

The processor 210 of the second device 200 may be configured to implement the operation of the second device in the embodiments described herein.

The memory 220 of the second device 200 may be connected to the processor 210 and store instructions executed by the processor 210.

### DESCRIPTION OF REFERENCE NUMERALS

100: first device
110: processor of first device
120: memory of first device
200: second device
210: processor of second device
220: memory of second device

1. A method performed by a first device within an intent-based network (IBN) framework, the method comprising:
translating an intent received from a user into a high-level policy;
transmitting the high-level policy to a second device;
receiving a result of monitoring an operation and/or performance of a service function (SF) from the second device; and
analyzing the operation and/or performance of the SF based on the monitoring result,
wherein the high-level policy is i) a network policy (NP) or ii) an application policy (AP), and
wherein the SF is performed by the second device based on the high-level policy.

2. The method of claim 1, wherein the intent includes a declarative request related to a specific goal of a network.

3. The method of claim 1, wherein the intent includes i) an intent input from a user in a natural language format and ii) is translated into the high-level policy based on natural language processing (NLP).

4. The method of claim 1, wherein the SF includes i) a network function (NF) and ii) an application function (AF).

5. The method of claim 4, wherein the NF is based on the network policy, and
wherein the AF is based on the application policy.

6. The method of claim 4, wherein the NF is an SF related to i) network functions virtualization (NFV) and/or ii) software-defined networking (SDN).

7. The method of claim 4, wherein the AF is an SF performed by one or more applications included in the second device.

8. The method of claim 1, further comprising:
receiving information on capabilities of the second device from the second device; and
translating the intent into the high-level policy based on the information on the capabilities of the second device.

9. The method of claim 1, wherein the first device is a central cloud (CC), and
wherein the second device is a moving object (MO) or an edge cloud (EC).

10. A first device for processing user intent in an Intent-based network (IBN) environment, the first device comprising:
one or more processors; and
one or more memories which are connected to the one or more processors and store instructions executed by the one or more processors,
wherein the instructions translate the intent received from a user into a high-level policy, transmit the high-level policy to a second device, receive a result of monitoring the operation and/or performance of a service function (SF) from the second device, and analyze the operation and/or performance of the SF based on the monitoring result,
wherein the high-level policy is i) a network policy (NP) or ii) an application policy (AP), and
wherein the SF is performed by the second device based on the high-level policy.

11. A method performed by a second device within an intent-based network (IBN) framework, the method comprising:
receiving a high-level policy from the first device;
translating the high-level policy into a low-level policy;
performing a service function (SF) based on the low-level policy;
monitoring an operation and/or performance of the SF; and
transmitting the monitoring result to the first device,
wherein the high-level policy is translated into i) a network policy or ii) an application policy based on the intent, and
wherein the low-level policy includes a specific rule for a specific SF.

12. The method of claim 11, wherein the intent includes a declarative request related to a specific goal of a network.

13. The method of claim 11, wherein the intent includes i) an intent input from a user in a natural language format and ii) is translated into the high-level policy based on natural language processing (NLP).

14. The method of claim 11, wherein the SF includes i) a network function (NF) and ii) an application function (AF).

15. The method of claim 14, wherein the NF is based on the network policy, and
wherein the AF is based on the application policy.

16. The method of claim 14, wherein the NF is an SF related to i) network functions virtualization (NFV) and/or ii) software-defined networking (SDN).

17. The method of claim 14, wherein the AF is an SF performed by one or more applications included in the second device.

18. The method of claim 11, further comprising transmitting information on capabilities of the second device to the first device.

19. The method of claim 11, wherein the first device is a central cloud (CC), and
wherein the second device is a moving object (MO) or an edge cloud (EC).

20. A second device that performs a service function (SF) in an intent-based network (IBN) environment, the second device comprising:
one or more processors; and
one or more memories which are connected to the one or more processors and store instructions executed by the one or more processors,
wherein the instructions receive a high-level policy from a first device, translate the high-level policy into a low-level policy, perform the SF based on the low-level policy, monitor an operation and/or performance of the SF, and transmit the monitoring result to the first device,
wherein the high-level policy is translated into i) a network policy or ii) an application policy based on the intent, and
wherein the low-level policy includes a specific rule for a specific SF.
